(19) United States
(12) Patent Application Publication
(10) Pub. No.: US 2017/0033433 A1
(43) Pub. Date: Feb. 2, 2017

(54) Windshield Antenna

(71) Applicants: SHANGHAI AMPHENOL AIRWAVE COMMUNICATION ELECTRONICS CO., LTD., Shanghai (CN); AMPHENOL FINLAND OY, Espoo (FI)

(72) Inventors: Andreas WINKELMANN, Sindelfingen (DE); Christian FUHR, Schönaich (DE); Frank BERNHARDT, Sindelfingen (DE); Mario FALIERO, Vanda (FI); Björn CEDERBERG, Shanghai (CN); Xinshan ZHANG, Espoo (FI); Zlatoljub MILOSAVLJEVIC, Espoo (FI); Norbert LOTTERER, Eningen u. A. (DE)

(73) Assignees: Shanghai Amphenol Airwave Communication Electronics Co., Ltd., Shanghai (CN); Amphenol Finland OY, Espoo (FI)

(21) Appl. No.: 15/303,872

(22) PCT Filed: Apr. 14, 2014
(86) PCT No.: PCT/EP2014/057522

§ 371 Date: Oct. 13, 2016

(51) Int. Cl. H01Q 1/12; H01Q 1/32; H01Q 13/10; H01Q 1/48

(52) U.S. Cl. CPC H01Q 1/1271; H01Q 1/48; H01Q 1/325; H01Q 13/106

(57) ABSTRACT

The present invention concerns an antenna (20) with a layered structure, in particular a single or double layer antenna (20) integrated into vehicle-windshield having a conformal foil structure comprising a monopole arm (21) and ground plane arms (22, 23), wherein the antenna (20) has a transparency of 70%-90%.

### BACKGROUND OF THE INVENTION

The present invention relates to an antenna according to claim 1. The present invention therefore relates in particular to a multiband transparent antenna integrated into a window glass, in particular a front window of a car or vehicle for cellular connectivity such as GSM/W-CDMA/LTE bands, GPS, WiFi connectivity or similar technologies.

Windshield integrated antennas have been known in different configuration in the state of the art. For example the WO WO002012153663A1 concerns a windshield-integrated antenna is provided capable of improving antenna gain in a specific direction even without being an array antenna. This windshield-integrated antenna is a windshield-integrated antenna that is provided upon a glass plate which is attached to a vehicle, and is provided with a glass plate, an artificial medium disposed between the glass plate and the glass plate, and a feed element disposed upon the opposite side of the artificial medium side of the glass plate. The artificial medium has a dielectric layer and a pair of conducting layers configured by conductive elements which face each other across the dielectric layer. The feed element is disposed at a position such that the feed element is electromagnetically coupled to the conductive element that is nearer to the feed element.

Another example of an antenna wire embedded in a windshield, and/or vehicle incorporating the same is disclosed by US000007847745 B2. According this disclosure an antenna wire may be embedded in an interlayer (e.g., a PVB interlayer) that is surrounded by two substrates (e.g., glass substrates). The antenna wire includes a fixed end electrically connected to a component (e.g., a bus bar) and a free end mechanically held in the interlayer via an adhesive (e.g., an adhesive tape). Thus, it may be possible to reduce distortion of the antenna wire and/or cause the antenna wire to be disposed in a manner that more closely conforms to a predetermined pattern. In certain example embodiments of this document, the adhesive may be located at a non-visible portion of the windshield.

However, the known embodiments are related to different problems, such as antenna space limitation due to the volume constraint for aerodynamic and style design reasons. Inter alias this problem lead to integrate antenna on vehicle parts or more desirable to hide the antenna inside of them.

It is well known that antennas were installed on vehicle roof, such as metallic mast with the disadvantage to reduce the aerodynamic and disfigure the vehicle style. Alternative solution was to integrate the antenna in the exterior vehicle parts, e.g. inside of exterior rear mirror or inside the bumper in that way the aerodynamic characteristic and the design of the vehicle are preserved with the disadvantageous of to deteriorate the antenna performance due to the limited antenna volume available and to extra cable loss for embedded outside mirror solution and bumper solution, respectively.

A further aspect is the antenna performance as such. From this point of view, the exterior vehicle structure offers the most suitable location for antenna, and preferable—due to undesirable effects—a non-metallic area (e.g. windows glass area, as windshield, sunroof) will significantly help to reduce the antenna profile and to increase the performance comparing to a metallic area location (e.g. metallic roof, hood). Also usually the area available on the vehicle glass can be significantly big and antenna size can be greatly and advantageously expanded.

However, another disadvantage of windshield-integrated antenna is based on the fact that the driver view is adversely influenced by the position and the transparency of the antenna. Any object placed on windows glass in such a way that obstruct or reduce the driver view is moreover against the law in most of the countries. Therefore there is a need for appropriate transparency complying with the law. Typically transparency required for automotive windshield must be greater than 70% to 75%.

A conformal antenna integrated inside the glass sandwich (e.g. laminated windshield glass) is a solution for aerodynamic, design points of view; also it's a robust and cost efficient solution, at same time as it is protected from glass layers, and it can be automatically assembled.

Windshield for vehicles are typical configured as a laminated glass structure, e.g. car commonly consists of two layers of glass, with 1.5 mm up to 2.5 mm thickness and electric permittivity between 6 to 8, bonded together by a resin of plastic interlayer such as Poly-Vinyl-Butyral (PVB) with a thickness around 0.5 mm or 1 mm and electric permittivity between 3 and 4.

In regard to the problem with the transparency, nowadays, different transparent conductive materials, such as Thin Conductive Oxide (TCO), Carbon NanoTubes (CNT), Metal Nano-Wires (MNW), Graphene films, Indium Thin Oxide (ITO) are proposed in order to make a conductive foil transparent, it's usually with a high level of transparency, around 80%. However a substantial disadvantage is the limited electric conductivity (10˜10̂5S/m) of such materials that deteriorates the antenna performance. Screen printed silver based paste is also one known alternative, being proposed.

Another way to overcome the above said problem is to use a meshed copper structure dense enough with a good trade-off between transparency and RF performance.

Usually a double layer antenna structure is used for a foil antenna to be integrated or laminated into glass sandwich in order to have more design flexibility but with the drawbacks that can be thicker for the laminated glass integration, and can be not very cost efficient comparing to a single layer antenna structure. However, a single layer antenna structure can be more easily fabricated, thinner, simple to integrate into glass sandwich.

It is to mention that current antenna integrated into windshield cannot have a transparency less that level of 70% to 75%. Moreover, antennas placed on vehicle glass, as above mentioned reasons, shall be aerodynamic and not deteriorate the design, robust and finally also cost efficient. Also the antenna RF cable shall satisfy the same requirements cited previously.

Therefore an object of the present invention is to overcome the above-mentioned problems and to provide an antenna for a vehicle having a good transparency, good electric conductive without worsening the vehicle design and easy to fabricate, integrate and connect.

To overcome the above said problems an antenna integrated into a laminated vehicle-windshield is provided having a transparency of 70%-90% or in particular 70%-80%, in particular having a conformal foil structure comprising a monopole arm and ground plane arms, wherein the antenna has a transparency of 70%-90% or in particular 70%-80%. Alternatively the transparency can appropriated be configured in any one of the ranges which falling in the above mentioned range between 70% and 90%. This means each combination of a bottom and a top value within the values 70%, 71%, 72%, . . . , to 88%, 89%, 90% is forming an inventive range according to the present invention (e.g. 73%-86% or 75%-77%). In a preferred embodiment a single layer antenna integrated into a vehicle-windshield is provided having a conformal foil structure comprising a monopole arm and ground plane arms, wherein the antenna further comprises at least one zone with a co-planar wave guide structure, a microstrip-line and an RF-cable to be connected to a head unit or a RF-unit, wherein the antenna has a planar foil structure that can be bent conformally to the windshield and wherein the antenna has a transparency degree of 75% or higher. The meaning of the feature “transparency” according to the present invention is the total transparency (transparency degree) through the surface of the antenna structure in the thickness direction of the antenna that means in the thickness direction of the glass where the antenna is integrated.

The single layer antenna is preferably configured in a manner wherein the antenna can be bent conformally to the windshield together with the co-planar wave guide structure.

The present invention also provides a single layer antenna, wherein a strip-line is provided to connect the antenna with a head unit or RF-unit and the strip-line comprises the micro-strip line and the RF-cable.

In a preferred embodiment of the invention the co-planar wave guide structure is configured to allow to preserve a single layer structure and to connect the antenna through the microstrip-line and the RF cable to the head unit or to the RF-unit.

According to an advantageous embodiment of the present invention the antenna is placed with its co-planar wave guide structure inside the laminated glass of the windshield, further preferably the microstrip-line is also placed inside the laminated glass of the windshield.

A further aspect of the invention concerns the position of the the microstrip-line which is placed on the interface of PVB layer and an outer glass layer.

Moreover, the zone with the co-planar wave guide structure and a microstrip-line pad area of the strip-line “may be soldered” together in order to ensure a correct alignment between them.

The following features are features of the antenna in a preferred embodiment according the present invention, whereas the antenna may comprise the following features in isolation or in combination:

The structure of the antenna is preferably formed by a plastic substrate made of 50 μm Polyethylene terephthalate (PET) thickness.

The structure of the antenna is further preferably formed by an electric conductive part, wherein the monopol arm (21) and at least one of the ground plane arms (22) is constructed by a thin uniform mesh structure of a copper with 20 μm and 260 μm of line width and spacing.

The zone with the co-planar wave guide structure is preferably made by solid copper of 12 μm (0.012 mm) thickness.

The antenna is preferably configured for GSM850/900/1800/1900, UMTS2100 and/or LTE 7/17 cellular operating bands at 50 Ohm.

The antenna grounding connection to the RF-cable is preferably used to generate the lowest low band (LB) resonance and the other low-band resonances, in order to cover the GSM850/900, LTE17 bands, which are related to the overall length of a feed arm and a grounding arm.

The high band resonances for GSM 1800/1900, UMTS 2100 and LTE 7 are preferably provided by a slot mode of the feed arm and the gap between feeding and grounding arms.

The antenna described above integrated into glass sandwich can be advantageously robust and protected from vandalism hazard.

Due to close location to the head unit, normally placed into or near by the dash board, a windshield antenna can easily be with less loss due to a short RF-cable. Another advantage of the invention is to use thin meshed line structure of conductive material, e.g. copper, to ensure good conductivity, high level of transparency to the antenna pattern.

Nevertheless, a single layer antenna structure is easy to be implemented during the glass lamination process, and with the advantage that it doesn't require any other structure such as capacitive coupling structure to be applied during the vehicle assembly, however the transparent antenna integrated into a windshield with a coplanar waveguide structure is a plug-and-play solution that can be cost efficient from assembly point of view.

### DESCRIPTION OF THE DRAWINGS THE EXEMPLARY EMBODIMENTS

A more complete appreciation of the invention and many of the attendant advantages thereof will be readily obtained as the same becomes better understood by reference to the following detailed description when considered in connection with the accompanying drawings, wherein:

FIG. 1 is perspective view of windshield of a vehicle within an explanatory example of an antenna;

FIG. 2 is a view of a single layer antenna in accordance with an exemplary embodiment of the present invention;

FIG. 3 is a sectional view of the antenna sandwiched in a glass layer;

FIG. 4 is a view of a single layer antenna in accordance with an alternative exemplary embodiment of the present invention, and

FIG. 5 is an illustrations showing the reflection coefficient of antenna (magnitude in dB) versus frequency in the frequency band from 0.6 GHz to 3 GHz;

FIG. 6 is an illustration showing simulated antenna efficiencies in dB for the same frequency band as in FIG. 5;

FIG. 7 is a diagram showing the gain (3D Mean and Max Values for Total, Theta, Phi and the gain for the corresponding solid angle values) measured depending on the frequency in the band range between 0.6 GHz and 3 GHz and

FIGS. 8 and 9 are examples for a mesh structure as heat protection.

Hereinafter, a mode for carrying out the invention will be described with reference to the drawings.

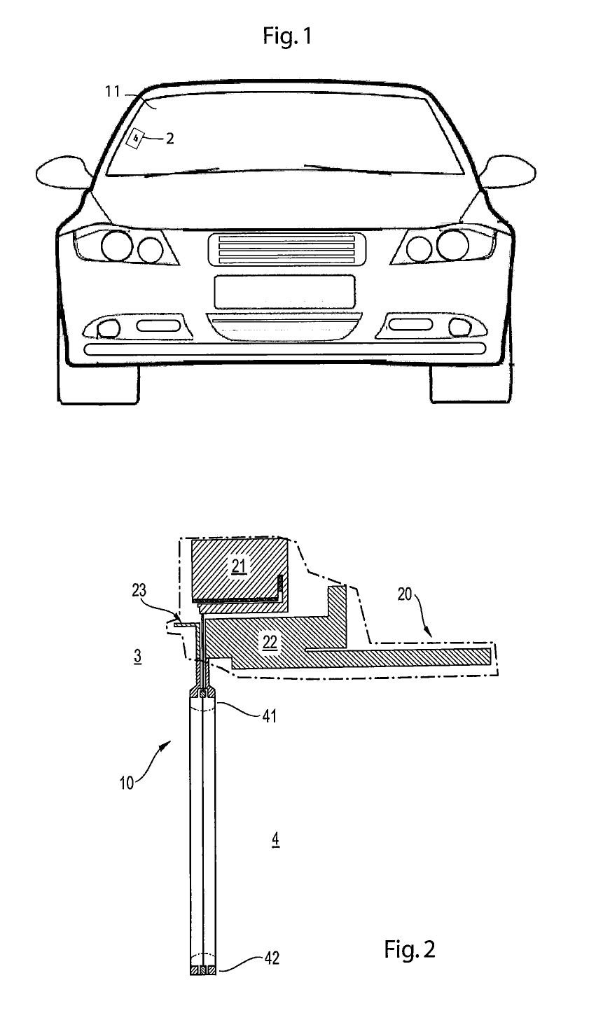

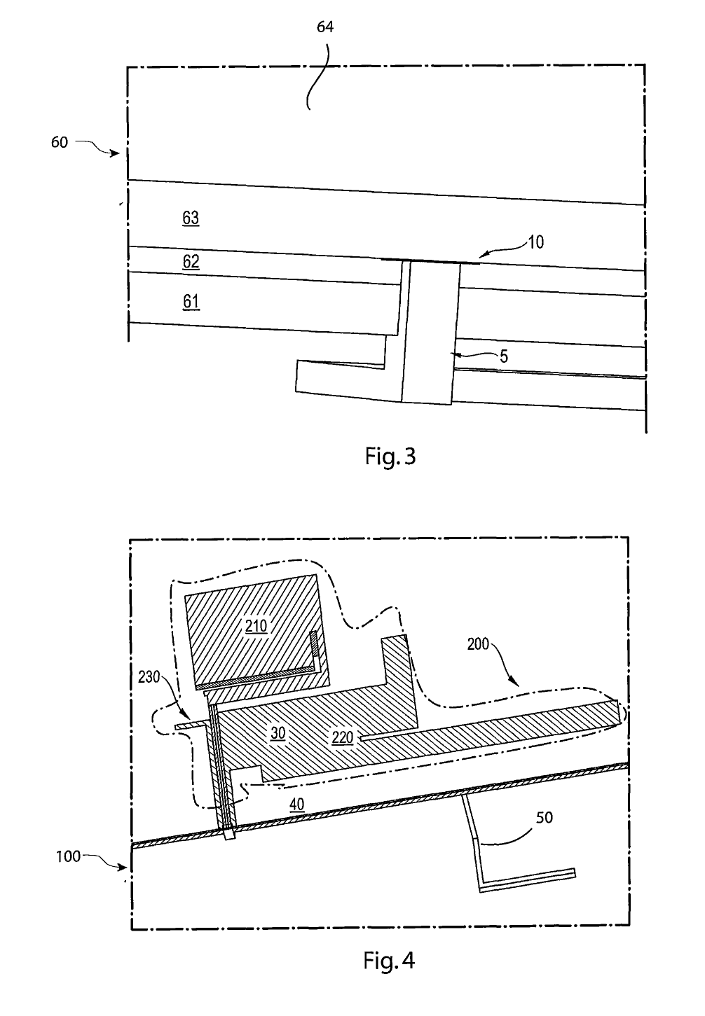

With reference to FIGS. 1, 2, 3 and 4 according to an exemplary embodiment of the present invention a single layer transparent antenna integrated into vehicle windshield 11 having a conformal foil structure which is connected with the Radio frequency unit or Head unit trough micro-strip line 10. With reference to FIGS. 2 and 3 the antenna structure 20 consist of a monopole arm 21, and two ground plane arms 22, 23. A co-planar wave guide structure zone 3 (also mentioned as “CPW”) allows to preserve a single layer structure and to connect the antenna through a microstrip-line 4 and an RF cable 5 to the head unit. Moreover, the antenna 20 with its CPW 3 parts is a planar foil structure that can be bent conformally to the glass.

The antenna 20 with its CPW structure 3 and microstrip-line 4 are placed inside the laminated glass 60 (see FIG. 3) of layers 61, 62 and 63, in particularly on the interface of the layer 62, which is a PVB layer and the “inner side” of the outer glass layer 63. The strip line is arranged along the adjacent contact surfaces of the layer 62 and the glass layer 63. The CPW structure 3 and microstrip-line pad area 41 are in the preferable embodiment soldered together, in order to ensure a correct alignment between them.

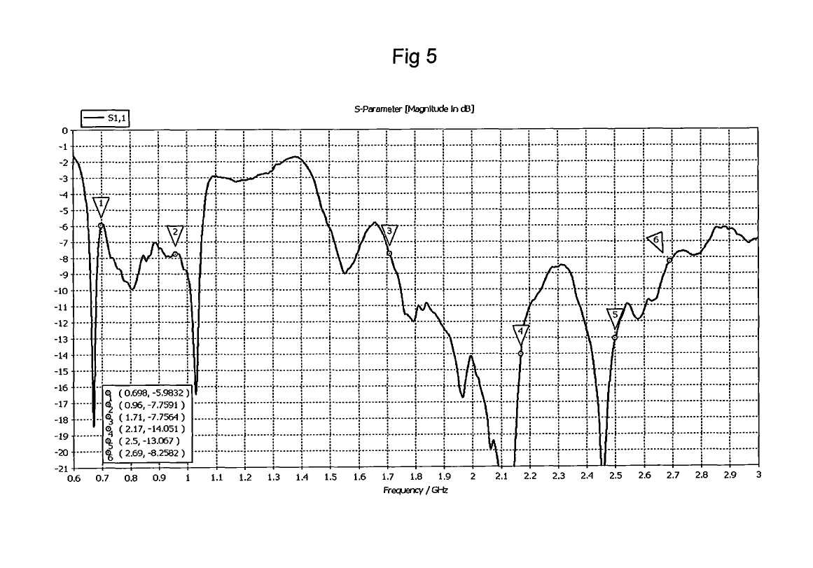

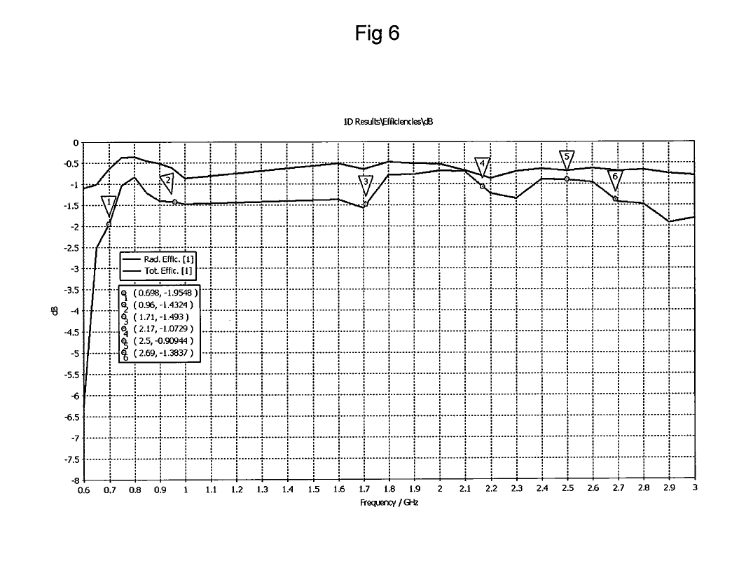

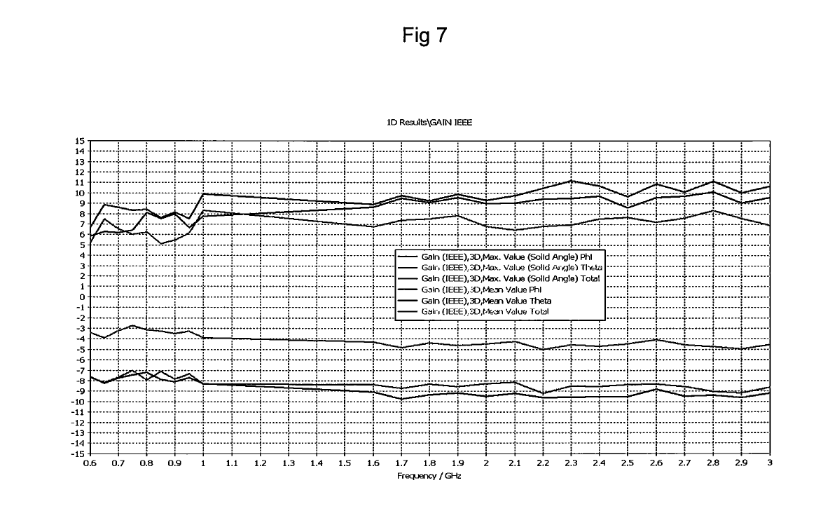

FIG. 4 shows a further preferred embodiment 100. The antenna 200 according to this embodiment is designed for GSM850/900/1800/1900, UMTS2100, LTE 7/17 cellular operating bands at 50 Ohm. An excellent impedance bandwidth is consequently achieved. FIG. 5 is an illustrations showing the reflection coefficient of antenna (magnitude in dB) versus frequency in the frequency band from 0.6 GHz to 3 GHz and FIG. 6 is an illustration showing simulated antenna efficiencies in dB (with included mismatch loss) and radiation efficiency for the same frequency band as in FIG. 5. The antenna grounding connection to the RF cable 50 is advantageously used to generate the lowest low band (LB) resonance. Alternatively, LB bandwidth will also be sufficiently good even without specifically grounding cable at any point in the close proximity to antenna. The other LB resonances are related to the overall length of the feed arm 210 and grounding arm 220 in order to cover the GSM850/900, LTE17 bands. The high band resonances for GSM 1800/1900, UMTS 2100 and LTE 7, are related mostly to the slot mode of the feed arm 210 and the gap between feeding and grounding arms 220. Also, the antenna gain shows excellent value, above −3 dBi on the whole band. With reference to FIG. 6 the gain (3D Mean and Max Values for Total, Theta, Phi and the corresponding solid angle values) are measured depending on the frequency in the band between 0.6 GHz and 3 GHz.

Moreover an antenna is provided wherein the antenna grounding connection to the RF-cable is used to generate the lowest low band (LB) resonance and the other low-band resonances, in order to cover the GSM850/900, LTE17 bands, which are related to the overall length of a feed arm and a grounding arm and/or wherein the high band resonances for GSM 1800/1900, UMTS 2100 and LTE 7 are provided by a slot mode of the feed arm and the gap between feeding and grounding arms.

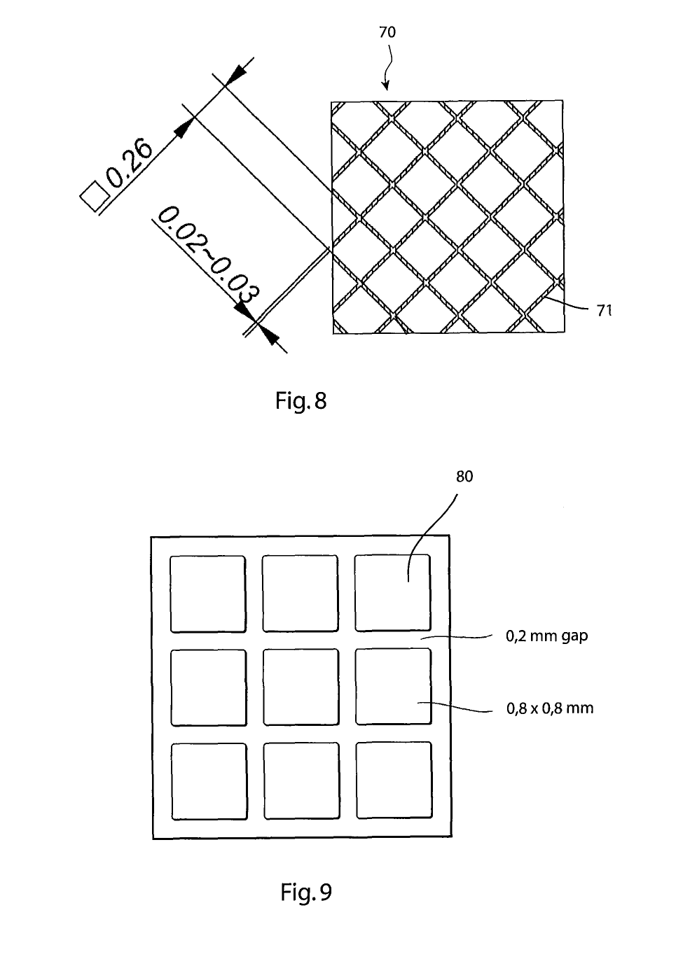

FIG. 8 shows antenna pattern 70 for transparent feature. So, there copper line 71 is about 20-30 μm and empty space between two adjacent copper lines is 260 um×260 um. FIG. 9 shows the opposite situation. The gap mentioned there of 0.2 mm is empty space and the square of 0.8 mm×0.8 mm is made of heat protection material 80, which may be to some extent conductive.

An possible embodiment of the structure is formed by a plastic substrate made of 50 μm Polyethylene terephthalate (PET); and by an electric conductive part, which part of it, 21 and 22, is constructed by a thin uniform mesh structure of a copper with 20 μm and 260 μm of line width and spacing, respectively (as illustrated with a mesh detail shown in FIG. 9; all dimensions in [mm]), and the CPW part is made by solid copper 12 μm. The embodiment 10 shows a transparency better than 75% and a low electric resistance, thus high conductivity needed for antenna operation.

The antenna structure, in a further preferred embodiment, is DC and RF connected to the 50 Ohm microstrip line through the pads 42 located at the end of the CPW line 41.

A typical microstrip line 4 consists of approximately 0.2 mm (200 μm) wide conductive line separated from the ground plane by 50-100 μm thick Polyamide (PI) substrate. Polyamide and PET substrate plastic can withstand up to 160 C temperature which is the usual temperature during the lamination process of a windshield.

An embodiments is to place the invention inside the windshield during the lamination process, between the glass and the thermoplastic, e.g. PVB interface, FIG. 3. The region 64 commonly utilized in windshields for light and glares reduction, may be advantageously used to render the invention less visible.

Alternative embodiment of the presented invention is a dual layer transparent antenna, for example the antenna structures 21 and 22 are located onto two PET substrate faces, and the CPW structure 3 is replaced by a microstrip-line structure. This is so called dual-layer structure. In this case the structure can be utilized to make the microstrip line from the same foil and no additional production/connection step is needed to attach antenna and transmission line. This structure can also be made from different than PET material, as for example Polyamide, also possible LCP, Teflon based substrates, PEN (Polyethylene naphthalate) and similar substrates. This also applies to microstrip line.

Another preferable embodiment is to use a full copper antenna structure when the antenna pattern can be hidden on the area 64 or in cases when the transparency is not required. This can mean for example that antenna part 22 (or a part of it), FIG. 2, is made from the solid (non-rastered) copper (or any other conductive material, as aluminium) conductor, also the CPW line can be made from solid metal. In this case as if part of antenna is made in the area 64 no any special requirement for transparency is needed. Alternatively, an antenna design without a CPW can also be used in connection with the idea of the present invention. This can be for example a dipole type of structure. Thus, the invention is not limited to the above mentioned preferred embodiments and can be applied to an alternative antenna type structure.

The antenna pattern 20 and 200 depicted in the FIG. 2 and FIG. 4, respectively, show a preferred embodiment of the presented invention, different several antenna concepts can be implemented in the same way of the preferred embodiments, e.g. Inverted F-antenna (IFA), an inverted L-Antenna (ILA), a loop antenna, patch, dipole structure etc.

Different way to connect electrically the antenna to the RF cable represents further embodiment. Further embodiments, for example FIG. 2, the microstrip-line pad area 41 can be capacitively or inductively coupled to the antenna structure. A further embodiment is to align the microstrip-line pads 41 and the CPW pads 3, without soldering them. This will be a capacitively coupled connection due to a close proximity of pads and their large enough size (capacitance for the certain frequency). Another connection method is also to utilize the conductive adhesive or glue, which will ensure the galvanic connection between them after that the glass lamination process will be finished.

Another alternative is also to place the antenna foil on the interlayer between layers 61 and 62. The invention is not restricted to the PI and PET substrate materials, but different polymers that can stand with the lamination temperature process can be used.

One more alternative is to have the whole structure made from 2 parts, of which both are single-layer structures. This can be for example that antenna, 20 (FIG. 2), is made on one single-layer transparent part. Another single layer part can be for example feeding line. Those 2 layers can be either placed on top of each other, or they can be located on 2 different sides of another layer as for example on 2 different sides of PVB layer (layer 62 on FIG. 3). In this case these 2 parts are then capacitively (electromagnetically) coupled to each other.

Multiple antenna structures can coexist on the same glass, for example another embodiment can be Multi Input Multi Output-structures, or different antenna radiators can be placed for different radio technologies, such as AM/FM and Cellular antenna structure can represent another embodiment. This can mean for example that as on FIG. 1 is shown only one antenna structure, also another similar or different (transparent) antenna can be located on the other side of windscreen (as for example on the driver side). There can also be several antenna structures on a single antenna foil, for example one FM structure and one cellular antenna structure. It is also possible to utilize one antenna structure that is connected to several feeding lines for operation at different frequency bands or overlapping frequency bands for MIMO use. Those can be utilized as main and Multi Input Multi Output-structures LTE antennas. The second antenna can also be placed on a different place as in the top area of a windshield. Alternatively the second antenna can be placed on any other place on the car (as shark fin structure, mast or whip roof antenna, side mirror antenna, bumper placement etc).

Further embodiments is to integrate a transparent antenna with another vehicle parts on the glass, such as the integration of an antenna with a defogger structure, which can be used for enhancing the antenna performances, for example for steering the antenna beam or generate an advantageously coupling between them, e.g. the defogger can be used for extending the grounding area.

Another option is to have a raster mesh created on a heat protection layer. This heat protection layer is many times present in a modern car glass structure, it is coated with a special material (a kind of conductive material). This layer reflects the outside heat waves and thus protects the compartment/interior from overheating. This continuous layer can interfere with the antenna structure in a negative manner. However, by rastering this layer with, for example, lasering it in a structure that is made from small pixels, it can become ‘invisible’ to the antenna RF structure. This kind of example is illustrated in FIG. 9, where just a typical pixel size of 0.8 mm×0.8 mm is shown. This kind of rastered area should be somewhat larger than the antenna area itself, it can overlap completely with the antenna (parallel layers) and its effect on antenna performance is negligible.

This transparent, glass antenna structure, is not limited to only automotive applications. It can be utilized for any other vehicle applications (as airplane, helicopter etc), but equally to any non-vehicle applications, as traditional glass, windows or even screens of any wireless devices (as mobile phones, tablets, computers, TVs etc).

While particular embodiments have been chosen to illustrate the invention, it will be understood by those skilled in the art that various changes and modifications can be made therein without departing from the scope of the invention as defined in the appended claims.

1. Antenna (20) with a layer structure integrated into a laminated vehicle-windshield, wherein the antenna (20) has a transparency degree of 70%-90%, in particular of 70%-80%.

2. Antenna (20) according to claim 1, wherein the structure of the antenna (20) is formed by a metal structure with a mesh-raster.

3. Antenna (20) according to claim 1, wherein the antenna (20) is a single or double layer antenna.

4. Antenna (20) according to claim 1, wherein the antenna (20) has a planar foil structure that can be bent conformally to the windshield.

5. Antenna (20) according to claim 1, wherein the antenna (20) further comprises at least one zone (3) with a coplanar wave guide structure, a microstrip-line (4) and a cable (5), in particular a RF-cable, to be connected to a head unit or a RF-unit.

6. Antenna (20) according to claim 1, wherein a strip-line (10) is provided to connect the antenna (20) with a head unit or RF-unit and the strip-line (10) comprises the micro-strip line (4) and the RF-cable (5).

7. Antenna (20) according to claim 5, wherein the co-planar wave guide structure is configured to allow to preserve a single layer structure and to connect the antenna through the microstrip-line 4 and the RF cable 5 to the head unit or to the RF-unit.

8. Antenna (20) according to claim 5, wherein the antenna (20) with its co-planar wave guide structure (3) is placed inside the laminated glass of the windshield.

9. Antenna (20) according to claim 7, wherein microstrip-line (4) is placed inside the laminated glass of the windshield.

10. Antenna (20) according to claim 8, wherein the antenna (20) and the microstrip-line (4) is placed on the interface of PVB layer (62) and an outer glass layer (63).

11. Antenna (20) according to claim 5, wherein the zone (3) with the co-planar wave guide structure and a microstrip-line pad area (41) of a strip-line (10) are soldered together in order to ensure a correct alignment between them.

12. Single or double layer antenna (20) according to claim 1, wherein the structure of the antenna (20) is formed by a plastic substrate made of approximately 50 μm Polyethylene terephthalate (PET) thickness.

13. Antenna (20) according to claim 1, wherein the structure of the antenna (20) is further formed by an electric conductive part, wherein a monopol arm (21) and at least one of ground plane arms (22) is constructed by a thin uniform mesh structure of a copper with 20 μm and 260 μm of line width and spacing.

14. Antenna (20) according to claim 5, wherein the zone (3) with the co-planar wave guide structure is made by solid copper of 12 μm thickness.

15. Antenna (20) according to claim 1, wherein the antenna (20) is configured for GSM850/900/1800/1900, UMTS2100 and/or LTE 7/17 cellular operating bands at 50 Ohm.
